(19) United States
(12) Patent Application Publication
(10) Pub. No.: US 2004/0256832 A1
(43) Pub. Date: Dec. 23, 2004

(54) Method of attaching an accessory such as a running board to a vehicle

(76) Inventors: Ross Bradsen, Huntsville (CA); Donald P. Chevalier, Huntsville (CA); Nathan Keith, MacTier (CA); Shawn Wale, Washago (CA)

Correspondence Address: HARNESS, DICKEY & PIERCE, P.L.C., P.O. BOX 828, BLOOMFIELD HILLS, MI, 48303, US

(21) Appl. No.: 10/600,161

(22) Filed: Jun. 20, 2003

(51) Int. Cl. B60R 3/00

(52) U.S. Cl. 280/163

(57) ABSTRACT

A method of attaching a vehicle accessory such as a running board, to a vehicle for assisting in entry and exit from the vehicle as well as protecting the body of the vehicle is disclosed, comprising an accessory such as molded running board and/or substructure with a plurality of receiving zones for receiving the mounting arm brackets, and further comprising a means of securing the accessory to the bracket by means of deflectable locking tab and aperture configuration. The securing means of the present invention requires no additional hardware for its attachment, thereby simplifying the mounting procedure, reducing manufacturing costs, while providing a strong, secure mount.

### FIELD OF THE INVENTION

The present invention relates to vehicle mounted accessories, such as running boards. Specifically this invention relates to the method of attaching accessories, such as a running board and its associated mounting bracket system to the vehicle.

### BACKGROUND OF THE INVENTION

In recent years running boards have gained popularity for use on four wheel drive vehicles, pick-ups, vans and other vehicles which are supported a substantial distance above the ground. The running boards facilitate entry into the vehicle.

Presently known running boards usually require one or more mounting brackets to be secured beneath the running board so as to support the running board against bending when subjected to weight loads. These transverse brackets are usually bolted or welded to the underside of the running board on their outboard ends and have holes or slots on their inner ends to attach the entire running board assembly to the vehicle using discrete mounting hardware, usually bolts or self-drilling screws.

Numerous running boards presently on the market are designed with the ease of manufacturing in mind as well as installation, but it is advantageous to have a running board which can be manufactured and assembled quickly, easily, and without the need for additional fasteners or hardware, thereby driving down production costs and time, while still maintaining a secure and strong assembly.

### SUMMARY OF THE INVENTION

It is an object of the present invention to provide a method of installing a running board on a vehicle without the need for fasteners between the running boards and mounting brackets and/or between the mounting brackets and the vehicle.

It is an object of the present invention to provide a method of installing a running board on a vehicle simply and quickly, without requiring additional tools.

It is an object of the present invention to provide a method of installing a running board on a vehicle which would significantly reduce production costs and time.

It is another object of the present invention to provide a method of installing a running board on a vehicle which will be secure enough to prevent inadvertent separation of the running board from the vehicle.

These and additional objects are achieved in a running board attachment method comprising one or more mounting brackets, which are attached to a vehicle, and received through one or more corresponding attachment zones located under the running board. A securing means such as one or more deflective tabs embodied in the running board/bracket system are provided which bias easily during insertion, but subsequently snap through corresponding apertures when the running board assembly is fully installed. The result is a secured attachment of the running board to the mounting bracket and/or the bracket to the vehicle with very little effort exerted or skill required, and no discrete fasteners used.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the running board as attached to a vehicle;

FIG. 2 is an exploded perspective view of a first embodiment of the mounting bracket and partial sectional view of the corresponding running board;

FIG. 3 is a cross-sectional view of the embodiment of the running board/mounting bracket of the present invention shown in FIG. 2, showing the running board being slid onto the mounting bracket;

FIG. 4 is a cross-sectional view similar to FIG. 3 showing the running board being slid further onto the mounting bracket;

FIG. 5 is a cross-sectional view similar to FIGS. 3 and 4 showing the running board fully attached to the mounting bracket;

FIG. 6 is an exploded perspective view of a second embodiment of the present invention and depicts the mounting bracket and partial sectional view of a corresponding running board;

FIG. 7 is an exploded partial perspective view illustrating a third embodiment of the present invention, showing the running board and mounting bracket, prior to assembly;

FIG. 8 is a partial perspective view of the embodiment of the present invention shown in FIG. 7, and illustrates the running board attached to the mounting bracket;

FIG. 9 is a partial cross-sectional, side view of the mounting bracket attached to a vehicle body panel, in accordance with the present invention; and

FIG. 10 is a perspective view of the mounting bracket illustrated in FIG. 9.

### DETAILED DESCRIPTION OF THE PREFERRED EMBODIMENTS

The following description of the preferred embodiment(s) is merely exemplary in nature and is in no way intended to limit the invention, its application, or uses.

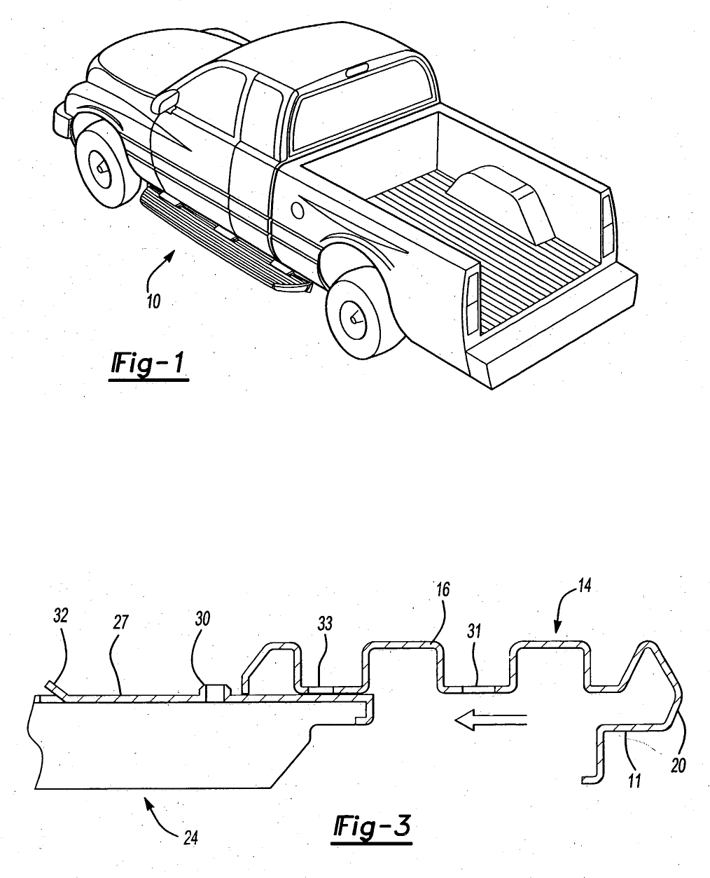

Referring to the figures, specifically FIG. 1, a running board assembly 10 is shown attached to a truck-type motor vehicle. The running board is generally a horizontal, elongated step attached to the vehicle by a mounting bracket located below the vehicle's doors for providing a step to assist in entry and egress from the vehicle.

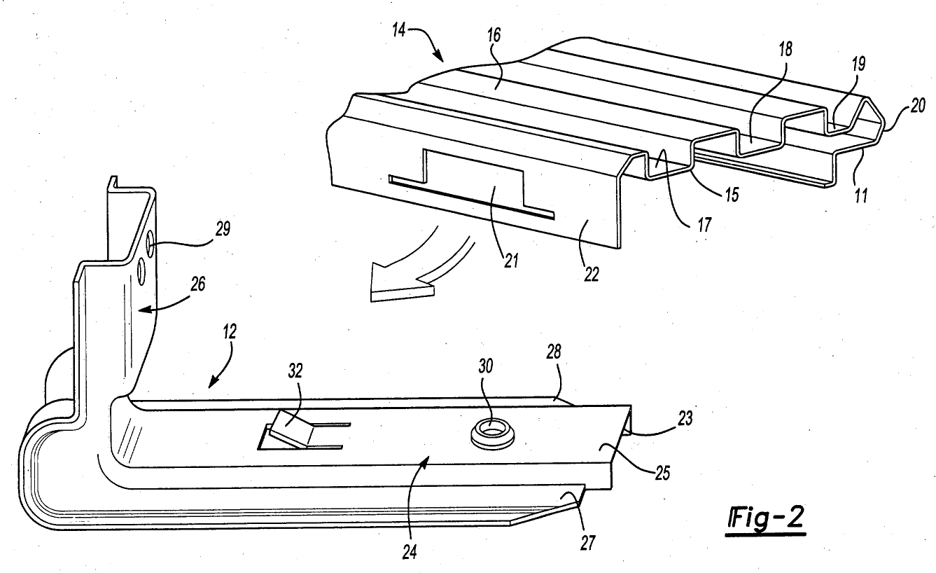

FIG. 2 illustrates the two general components of the present invention, the mounting bracket 12 and running board sub-structure 14, comprising the running board assembly 10. Each running board assembly 10 may embody a plurality of mounting brackets 12, depending on the length of the running board 14 for each individual application, as well as the load it will be subjected to, but the number of mounting brackets 12 per running board 14 is not intended to be a limiting factor of the scope of the present invention.

The partial-sectional view shown in FIG. 2 of the running board sub-structure 14 element, illustrates a first embodiment of the present invention comprising an upper surface 16 having a plurality of longitudinal channels 17, 18, and 19, bottom side 15, a turned under, outer edge 20, and a back edge 22 having a mounting slot 21 for receiving the mounting bracket arm 24 at each mounting location. The channels 17, 18, and 19 provide corrugated integrity to the running board 14.

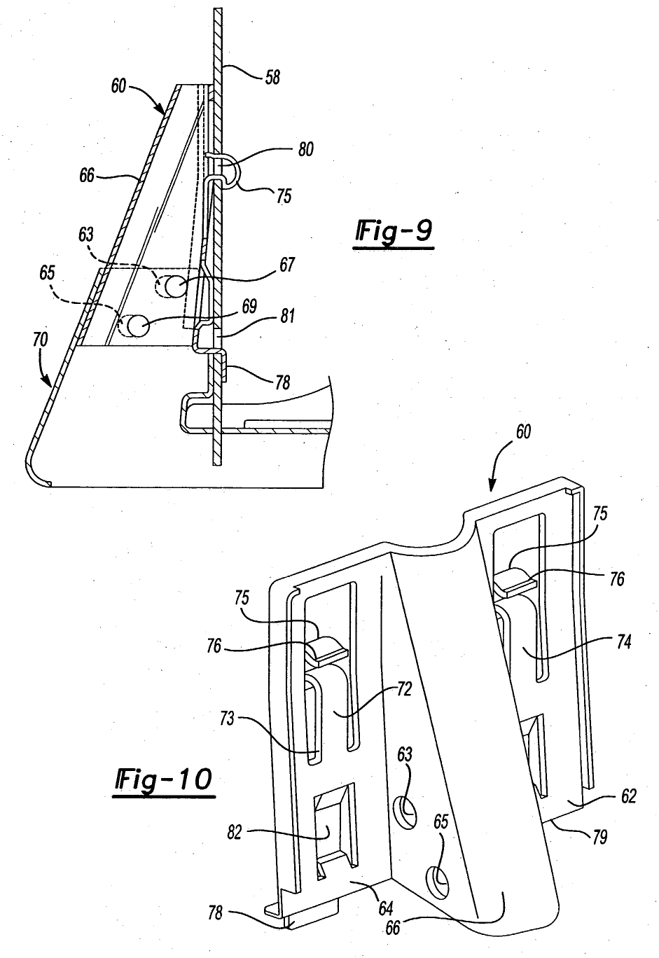

Each mounting bracket 12 comprises a mounting bracket arm 24 perpendicular to the vehicle attachment leg 26. The specific angle and design of each bracket 12 varies depending on the application, but generally comprises a U-shaped metal rail with flared edges 27 and 28, for increased strength, durability and resistance to bending. The vehicle attachment leg 26 comprises at least one aperture there through for securing the mounting bracket 12 to the vehicle by various means such as machine fasteners. Alternatively, the mounting bracket 12 may be secured to the vehicle without fasteners by any of the means depicted in FIGS. 9 and 10.

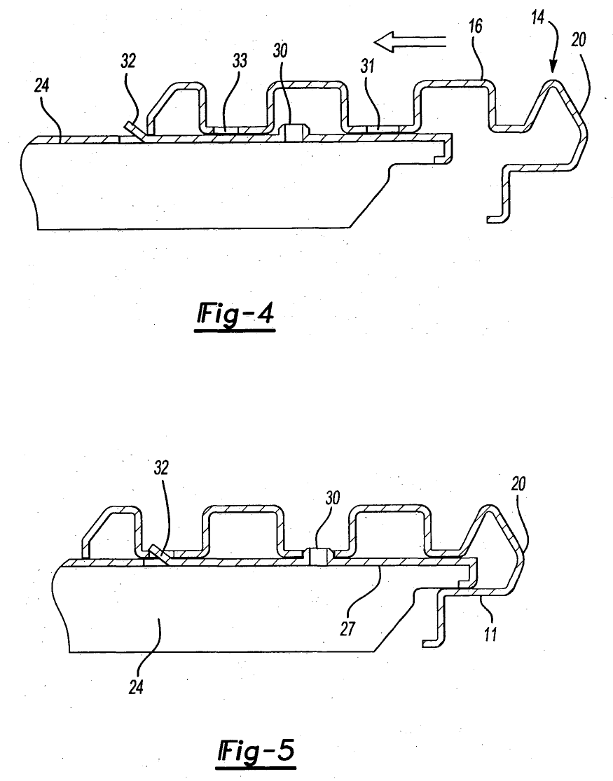

Each mounting bracket 12 has at least one attachment means, for securing the running board 14 to the mounting bracket arm 24. In a preferred embodiment as illustrated in FIG. 2, the mounting bracket 12 embodies both a chamfered post 30 and a deflectable tab 32, extending from the mounting surface 25 of the bracket arm 24, for engaging with a pair of corresponding receiving apertures 31 and 33 respectively shown in FIGS. 3-5.

To attach the running board assembly 10 to a vehicle, the mounting bracket(s) 12 are mounted to the vehicle by the use of conventional fasteners, or alternatively, by the fastenerless means depicted in FIGS. 9 and 10. The bracket arms 24 are orientated outwardly for installation of the running board 13, perpendicular to the direction of vehicle travel. To attach the running board 14 upon the mounting brackets 12 as shown in FIGS. 3-5, the brackets 12 are pushed into their corresponding slots 21 in the running board sub-structure 14 until the tab 32 and post 30 snap into their respective “home” positions 33 and 31.

More specifically, as the chamfered post 30 comes into contact with the back edge 22 of the running board 14, the running board 14 is deflected partially upwards. Similarly, when the deflective tab 32 comes into contact with back edge, the tab 32 is forced to deflect downward for its passage through the aperture 21. The running board continues to be inserted over the bracket arms 24 until the distal end 23 of the bracket comes into contact with the outer edge 20, wherein it rests upon lip 11. Once in this fully inserted position, the chamfered post 30 and deflective tab 32 are received through corresponding apertures 31 and 33 respectively, snapping into position and securing the running board 14 to the mounting bracket 12.

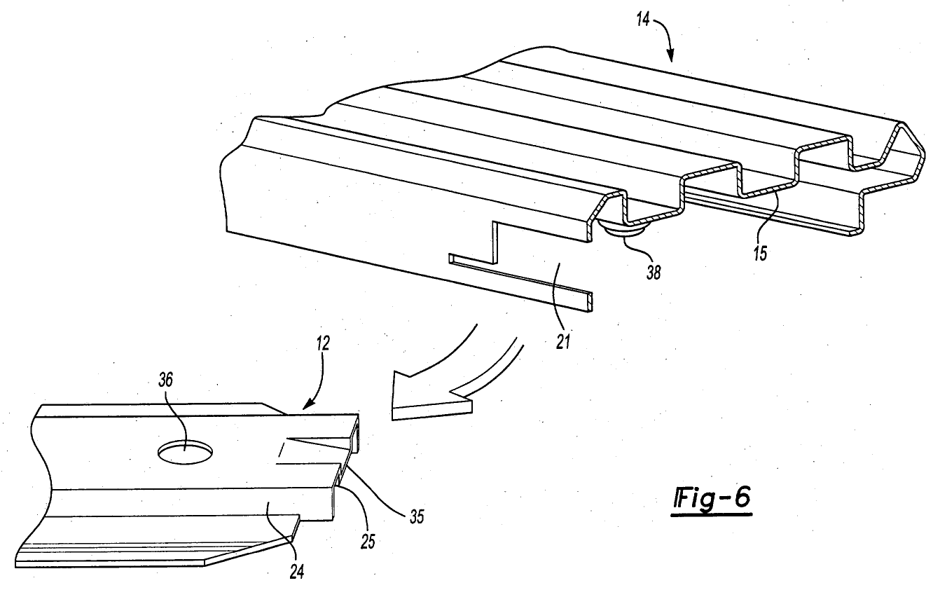

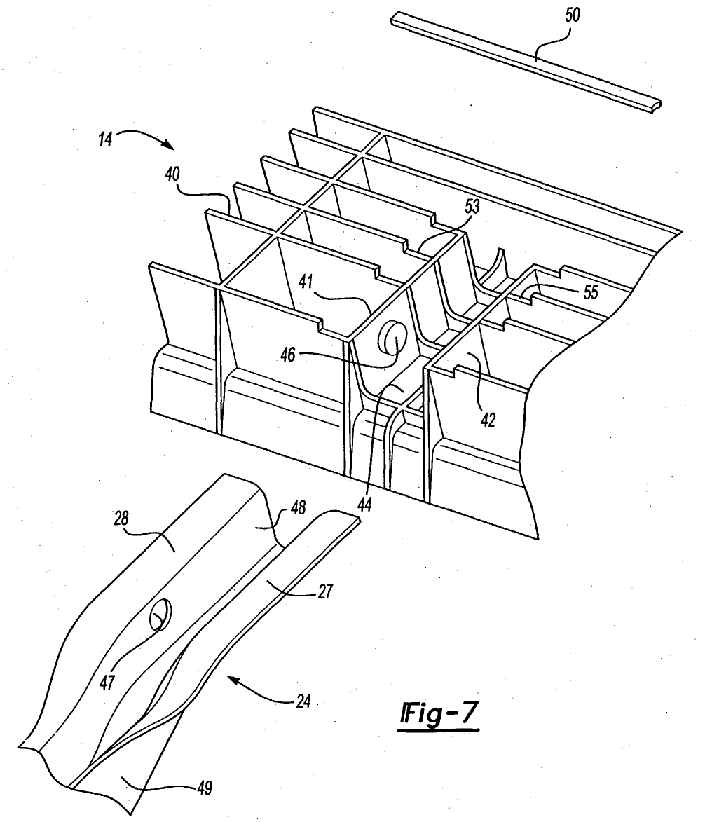

In accordance with an alternative embodiment of the present invention as illustrated in FIG. 6, the mounting arm 24 has a ramp 35 on the distal end 23 of the mounting bracket 12, and at least one receiving aperture 36 for receiving chamfered tab 38 located on the bottom side 15 of the running board 14. Similar to the above embodiment, during insertion of the mounting bracket into the aperture 21 of the running board 14, the ramp 35 contacts the chamfered tab 38 causing the bracket arm 24 to deflect away, until such time the arm 24 is fully inserted, at which time the bracket arm 24 snaps back when the chamfered tab 38 is received through the aperture 36, securely attaching the running board 14 to the mounting bracket 12. In both of the above embodiments, the force required to insert the running board 14 over the mounting brackets 12 is much less than that required to remove it, once “locked” and can usually be installed by one individual.

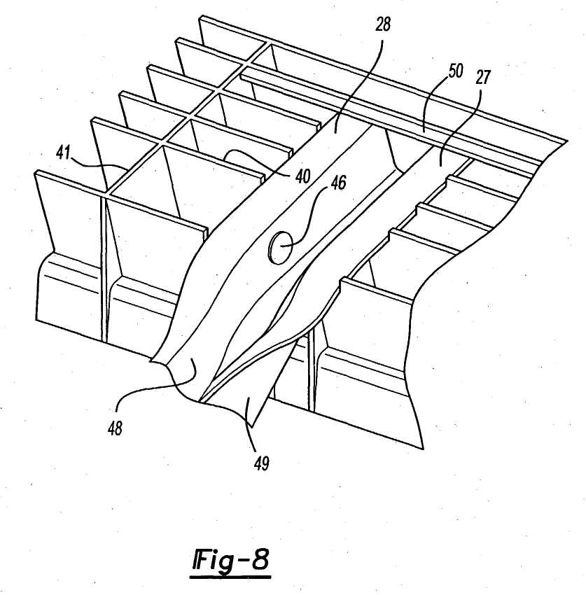

FIGS. 7 and 8 disclose yet another embodiment of the present invention, namely, a variation in the means of attaching the composite running board 14 to the mounting bracket 12. Specifically, the bottom side 15 of the running board 14 is partially shown at one mounting bracket 12 location, wherein the reinforcement ribs 40 are intersected by walls 41, 42 with a receiving groove 44 positioned there between, the walls 41, 42 thereby providing support on either side of the mounting bracket arm 24. Located on each walls 41, 42 is at least one retainer post 46, protruding inward towards the receiving groove 44 and having a chamfered edge, facing the bottom plane of the running board 14. These retainer posts 46 are received in corresponding apertures 47 within the walls 48, 49 of the mounting bracket 12 for securing it to the running board 14.

FIG. 7 shows the preassemble orientation of the bracket 12 and the running board 14, with the mounting lip 50 removed for illustration purposes. The mounting bracket arm 24 is inserted into the receiving groove 44, wherein the retainer posts 46 of the lateral walls 41, 42 bias the walls 48, 49 of the mounting bracket arm 24 inwards, until such time the retainer posts 46 are received through apertures 47 at which time the walls 48, 49 snap back outward, creating a secured attachment of the running board 14 to the bracket 12.

As previously explained, the flared edges 27, 28 of the mounting bracket arm 24 are received in shallow, corresponding recesses 53, 55 molded in the top of each rib 40 as well as the two walls 41, 42 allowing the mounting bracket 12 to be mounted flush with the bottom plane of the running board 14, minimizing the chance of snagging any debris the vehicle may be traversing over.

FIGS. 9 and 10 illustrate an alternative embodiment providing for the attachment of the mounting bracket to a vehicle body panel 58 or sub-frame, frame, without the need for additional fasteners. Generally, the mounting bracket comprises two elements: a mounting plate 60 having a pair of flanges 62, 64 forming a generally planar mounting surface separated by a formed, central ridge 66 having mounting holes 63, 65 for attaching the second element; the running board support arm 70. Though illustrating the preferred embodiment, the scope of the invention is not limited in the number of elements comprising the mounting bracket.

Each flange 62, 64 comprises a planar spring arm. 72, 74 formed in the mounting plate 60 with a anchored end 73 and a curved, deflectable end 75. The curved end 75 terminates in a semi-circular bend with an engagement groove 76 for engaging with a corresponding aperture 80 in a vehicle body 58. Each flange 62, 64 further comprises a retaining lip 78 on a lower edge 79 for being received in a lower mounting aperture 81 in the vehicle body 58. A bridge portion 82 is located on each flange 62, 64, positioned between the spring arms 72, 74 and the retaining lip 78, acting as a cam which provides a tight, rattle-free abutment of the mounting plate 60 against the vehicle body 58.

The central ridge 66 is strong enough to securely attach and support the running board which attaches through holes 63, 65. Various fastener mounting means know in the art, or fastenerless mounting means as disclosed herein may be utilized, but in a preferred embodiment a pair of locking pins 67, 69 positioned on the horizontal running board bracket corresponds with the holes 63, 65 to form a secure attachment means, with minimal installation time and cost expenditure.

Although the invention as described and illustrated is directed towards the attachment of a running board to a vehicle, it should be noted that the principles of the invention may be applied to the attachment of a variety of vehicular accessories, and should not limit the scope of the invention to the method of attaching running boards per se. The description of the invention herein is merely exemplary in nature and, thus, variations that do not depart from the gist of the invention are intended to be within the scope of the invention. Such variations are not to be regarded as a departure from the spirit and scope of the invention.

What is claimed is:

1. A vehicle accessory mounting assembly comprising:
a running board structure, said structure comprising a generally planar upper surface, a plurality of reinforcing ribs on a bottom side there of, and at least one mounting bracket receiving slot;
a mounting bracket, said bracket being partially received in said receiving slot, said mounting bracket attaching to a vehicle;
a means of securing said structure to said bracket, said means comprising at least one deflectable tab on said mounting bracket received by a corresponding aperture in said running board when said mounting bracket is received in said receiving slot of said running board.

2. The vehicle accessory mounting assembly of claim 1, wherein said means of securing said running board structure to said bracket comprises at least one locking post on said running board structure proximal said receiving zone, being received in a corresponding aperture in said mounting bracket when said mounting bracket is received in said receiving zone of said running board structure.

3. The vehicle accessory mounting assembly of claim 1, wherein said means of securing said running board to said bracket comprises at least one deflectable tab on said mounting bracket received by a first complementary aperture in said running board and a locking post on said mounting bracket received by a second complementary aperture in said running board when said mounting bracket is received in said receiving zone of said running board.

4. The vehicle accessory mounting assembly of claim 1, wherein said means of securing said running board to said bracket comprising solely of one deflectable tab on said mounting bracket received by a corresponding aperture in said running board when said mounting bracket is received in said receiving zone of said running board.

5. The vehicle accessory mounting assembly of claim 1, wherein said means of securing said running board to said bracket comprising solely of one locking post on said running board proximal said receiving zone, being received in a corresponding aperture in said mounting bracket when said mounting bracket is received in said receiving zone of said running board.

6. The vehicle accessory mounting assembly of claim 1, wherein said means of securing said running board to said bracket comprising solely of one deflectable tab on said mounting bracket received by a first complementary aperture in said running board and a locking post on said mounting bracket received by a second complementary aperture in said running board when said mounting bracket is received in said receiving zone of said running board.

7. The vehicle accessory mounting assembly of claim 1, wherein said mounting bracket embodies the sole attachment means of attaching said bracket to said vehicle.

8. The vehicle accessory mounting assembly of claim 7, wherein said attachment means comprises at least one tab on said bracket being receivable by a corresponding first aperture on said vehicle, and at least one spring arm on said bracket being receivable by a corresponding second aperture on said vehicle to secure said bracket to said vehicle.

9. A method of attaching the vehicle accessory mounting assembly of claim 1 to a vehicle comprising the steps of:
attaching said mounting bracket to said vehicle;
positioning said running board structure adjacent said mounting bracket, aligning said mounting bracket with said mounting bracket receiving zone;
pushing said running board structure towards said mounting bracket, said mounting bracket being received in said mounting bracket receiving zone, said deflectable tab biasing while contacting the running board structure adjacent said receiving zone;
fully inserting said running board structure onto said mounting bracket, said deflectable tab being received by said aperture in said running board, said aperture preventing the removal of said deflectable tab.

10. A vehicle accessory mounting assembly comprising:
a vehicle;
an accessory, such as a running board, said accessory comprising at least one mounting bracket receiving slot;
a mounting bracket, said bracket being partially received in said receiving zone, having an accessory attachment means communicating with said accessory for securing said bracket to said accessory, and a bracket mounting means communicating with said vehicle for securing said bracket to said vehicle;
said accessory attachment means integrated into said mounting bracket to securingly communicate with a corresponding accessory attachment means receiving element, integrated into said accessory, said accessory attachment means embodying the sole means of securing said accessory structure to said mounting bracket;
said bracket mounting means integrated into said mounting bracket to securingly communicate with a corresponding bracket mounting means receiving element integrated into vehicle, said mounting means embodying the sole means of securing said mounting bracket to said vehicle.

11. A vehicle accessory mounting assembly comprising:
a vehicle accessory with a mounting bracket receiving zone;
a mounting bracket with an accessory mounting zone and a vehicle mounting zone;
a means of securing said accessory to said mounting bracket, said means comprising of deflectable protrusions integral with either the accessory or mounting bracket that locate into corresponding apertures in either the accessory or mounting bracket;
a means of securing said mounting bracket to a vehicle, said means comprising of deflectable protrusions integral with the mounting bracket or with integral fastening apertures that securely locate said bracket to said vehicle either with or without discrete fasteners.
